(19) United States
(12) Patent Application Publication
(10) Pub. No.: US 2012/0160206 A1
(43) Pub. Date: Jun. 28, 2012

(54) Piston of Internal Combustion Engine, Producing Method of Piston, and Sliding Member

(75) Inventors: Norikazu Takahashi, Yokohama-shi (JP); Masato Sasaki, Sagamihara-shi (JP); Takanori Sato, Atsugi-shi (JP)

(73) Assignee: Hitachi Automotive Systems, Ltd., Hitachinaka-shi (JP)

(21) Appl. No.: 13/337,352

(22) Filed: Dec. 27, 2011

(30) Foreign Application Priority Data
Dec. 28, 2010 (JP) 2010-291662

(51) Int. Cl. F02F 3/00; B05D 3/10; B05D 3/12

(52) U.S. Cl. 123/193.6; 428/217; 427/327; 427/329

(57) ABSTRACT

A piston of an internal combustion engine, having a crown section. A wear-resistant ring is formed in the crown section to be used for forming a piston ring groove. The wear-resistant ring includes a porous formed body formed of a first material higher in hardness and larger in specific gravity than a base material of the piston, and a second material infiltrated in pores of the porous formed body and containing 20 weight % or more of magnesium.

### BACKGROUND OF THE INVENTION

This invention relates to a piston of an internal combustion engine, whose piston crown is provided with an inserted wear-resistant ring, a method of producing the same piston, and a sliding member.

A piston of an internal combustion engine is formed of aluminum alloy taking account of requirement of weight-lightening, as well known. Since a combustion pressure applied on a crown section formed at the piston is high, there is a fear that a piston ring groove may be broken in case that a piston ring is directly provided into the piston ring groove formed at the outer peripheral surface of the crown section. Hence, a wear-resistant ring formed of Ni-resist cast iron is embedded or inserted in the crown section of the piston, and then a piston ring groove is formed around the outer periphery of the wear-resistant ring having a high strength, as disclosed in Japanese Patent Provisional Publication No. 2010-96022.

### SUMMARY OF THE INVENTION

However, the piston disclosed in the above publication has encountered such a problem that the weight of the whole piston unavoidably increases because the wear-resistant ring is formed of Ni-resist cast iron high in specific gravity as it is.

In view of the above conventional technical problem, an improved piston of an internal combustion engine, according to the present invention has been devised. An object of the present invention is to provide an improved piston of an internal combustion engine, which can be sufficiently suppressed in weight increase even though the piston is provided with a wear-resistant ring forming with a piston ring groove.

An aspect of the present invention resides in a piston of an internal combustion engine, comprising a crown section. A wear-resistant ring is formed in the crown section to be used for forming a piston ring groove. The wear-resistant ring includes a porous formed body formed of a first material higher in hardness and larger in specific gravity than a base material of the piston, and a second material infiltrated in pores of the porous formed body and containing 20 weight % or more of magnesium.

Another aspect of the present invention resides in a piston of an internal combustion engine, comprising a crown section. A wear-resistant ring is formed in the crown section to be used for forming a piston ring groove. The wear-resistant ring is produced by a process including preparing a porous temporary formed body formed of a first material higher in hardness and larger in specific gravity than a base material of the piston, and infiltrating a second material in pores of the porous temporary formed body, the second material containing 20 weight % or more of magnesium.

A further aspect of the present invention resides in a method of producing a piston of an internal combustion engine, including a crown section, and a wear-resistant ring formed in the crown section to be used for forming a piston ring groove. The method comprises in the sequence set forth: preparing a temporary formed body formed by solidifying powder of metal oxide which is higher in hardness and larger in specific gravity than a base material of the piston, the temporary formed body having pores; infiltrating a metal material smaller in specific gravity than the base material of the piston, into the pores of the temporary formed body under oxidation and reduction reactions between the temporary formed body and the metal material so as to form the heat-resistant ring; and fixing the heat-resistant ring in the crown section of the piston during casting of the base material of the piston.

A still further aspect of the present invention resides in a sliding member comprising a base section. A wear-resistant section higher in wear-resistance than a base material of the sliding member is partially formed in the sliding member. The wear-resistant section includes a porous formed body formed of a first material higher in hardness and larger in specific gravity than the base material of the sliding member, and a second material infiltrated in pores of the porous formed body and containing 20 weight % or more of magnesium.

A still further aspect of the present invention resides in a sliding member comprising a base section. A wear-resistant section higher in wear-resistance than a base material of the sliding member is partially formed in the base section. The wear-resistant section is produced by a process including preparing a porous temporary formed body formed of a first material higher in hardness and larger in specific gravity than the base material of the sliding member, and infiltrating a second material in pores of the porous temporary formed body, the second material containing 20 weight % or more of magnesium.

The other objects and features of this invention will become understood from the following description with reference to the accompanying drawings.

### BRIEF DESCRIPTION OF THE DRAWINGS

In the drawings, like reference numerals designate like parts and elements throughout all figures, in which:

FIG. 1 is a perspective view of an embodiment of a piston of a diesel engine, according to the present invention;

FIG. 2 is a vertical sectional view taken in the direction of arrows substantially along the line A-A of FIG. 1;

FIG. 3 is a perspective view of a wear-resistant ring to be used in the piston according to the present invention;

FIGS. 4A to 4C are vertical sectional views, showing a process of forming a compact by a punch forming machine;

FIG. 5 is a perspective view of a temporary formed body of the wear-resistant ring to be used in the piston according to the present invention; and

FIG. 6 is a vertical sectional view of a piston casting apparatus including a casting die, to be used for producing the piston according to the present invention, showing a state in which the wear-resistant ring is inserted during casting of the piston.

### DETAILED DESCRIPTION OF THE INVENTION

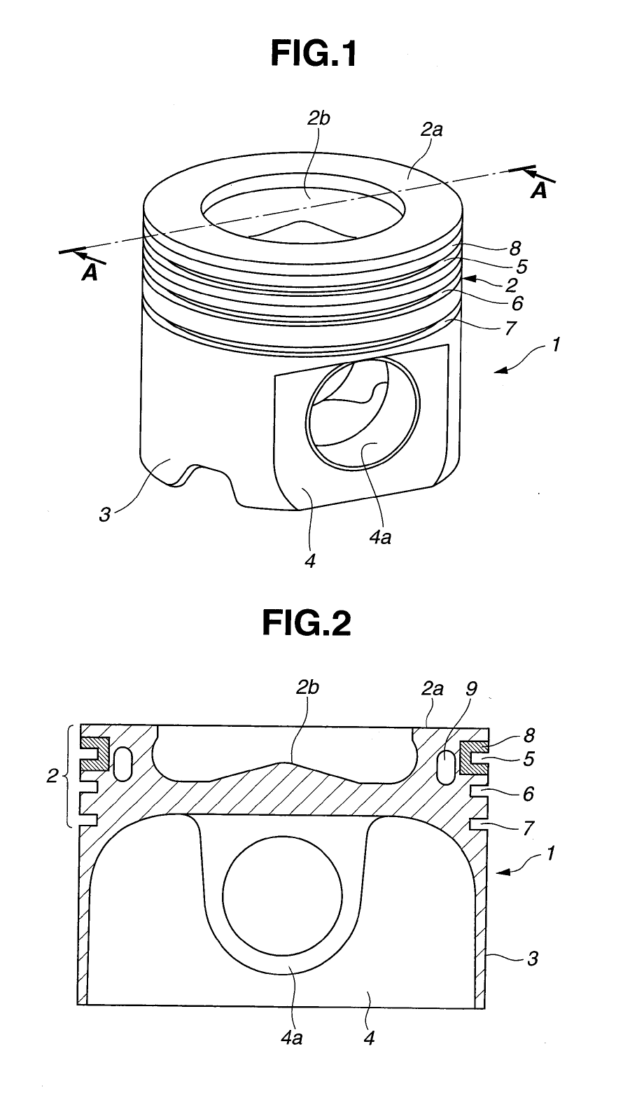

Referring now to FIGS. 1 and 2 of drawings, an embodiment of a piston of an internal combustion engine, according to the present invention is illustrated by the reference numeral 1. The internal combustion engine of this embodiment is a reciprocating diesel engine. Piston 1 is formed of an Al—Si based aluminum alloy (AC8A in Japanese Industrial Standard) as a base material and shaped as a one-piece structure. The AC8A has a chemical composition (mass %) of Cu: 0.8 to 1.3%, Si: 11.0 to 13.0%, Mg: 0.7 to 1.3%, Zn: 0.15% max., Fe: 0.8% max., Mn: 0.15. % max., Ni: 0.8 to 1.5%, Ti: 0.20% max., Pb: 0.05% max., Sn: 0.05 max., Cr: 0.10 max., and Al: balance. Piston 1 is formed generally cylindrical and includes a crown section 2 having a crown surface 2a defining thereon a combustion chamber. Thrust and anti-thrust side skirt sections 3 are formed integral with crown section 2 at a bottom end portion and formed generally semicylindrical. Two apron sections 4 are formed integral with crown section 2 at the bottom end portion and integral with skirt sections 3 in such a manner that each apron section 4 is located between skirt sections 3. Two pin boss sections 4a are formed integral respectively with two apron sections 4 to support the opposite end sections of a piston pin (not shown).

Piston 1 may be formed of a material (base material) containing a magnesium alloy in addition to the above-mentioned aluminum alloy as a base metal. This makes possible to accomplish a weight-lightening of the base material itself of the piston.

Crown section 2 is formed generally disc-shaped and relatively thick, and formed at its crown surface 2a with a circular depression 2b. Depression 2b is formed generally reversed M-shaped in section as shown in FIG. 2. Depression 2b forms part of the combustion chamber. Additionally, crown section 2 is formed with three circular piston ring grooves 5, 6, 7 which are coaxial and axially three-staged. Three piston ring grooves 5, 6, 7 are formed by machining (such as cutting, grinding and/or the like) the outer peripheral surface of the crown section after casting of piston 1 so as to support respectively three piston rings (not shown) such as a pressure ring, an oil ring and the like.

Further, a wear-resistant ring 8 as a sliding member is embedded or inserted within crown section 22. Wear-resistant ring 8 is coaxial with and located over piston ring groove 6, and formed generally U-shaped in section as shown in FIG. 2 so that an annular space is formed inside the wear-resistant ring and corresponds to piston ring groove 5. Additionally, an annular hollow 9 is formed within crown section 2 and located radially inward of wear-resistant ring 8 in order that oil for cooling flows through the annular hollow.

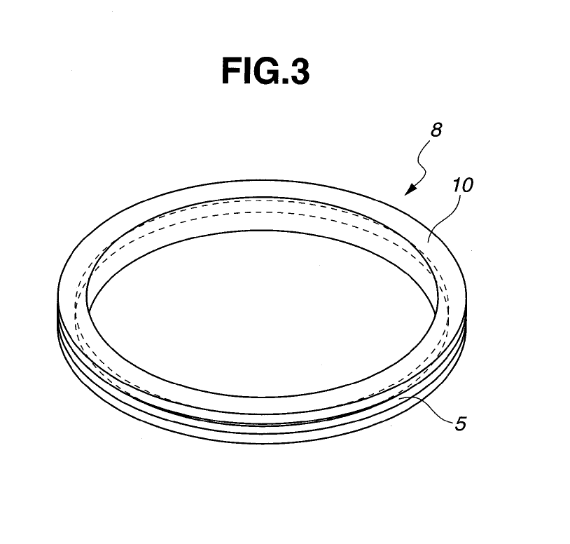

As clearly shown in FIGS. 2 and 3, wear-resistant ring 8 is provided to form piston ring groove 5 for supporting the pressure ring, at the upper-most stage side of the three piston ring grooves, after grinding of an outer peripheral portion of crown section 2. Wear-resistant ring 8 includes, as a matrix, a compact of Ni-resist cast iron which is a ferrous metal higher in hardness and larger in specific gravity than the aluminum alloy as the base material of the piston. The matrix is impregnated with an aluminum (Al) alloy and a magnesium (Mg) alloy and formed into an annular one-piece body. This wear-resistant ring 8 has been produced throughout the present inventors' extensive experiments as discussed in detail below.

Annular hollow 9 is located coaxial with wear-resistant ring 8 and around a center axis (not shown) of piston 1. Annular hollow 9 is located adjacent to and slightly radially inward of wear-resistant ring 8 with a slight radial distance such as about 3 mm. Additionally, almost whole parts or major parts of annular hollow 9 and wear-resistant ring 8 overlap each other in an axial direction of piston 1. It is preferable that wear-resistant ring 8 and annular hollow 9 are located as close as possible to the upper end side of the inner part of crown section 2, near the combustion chamber or depression 2b in order that wear-resistant ring 8 and cooling oil within annular hollow 9 absorb a high heat in the combustion chamber thereby effectively accomplishing a heat exchange between the combustion chamber and the outside thereof. Thus, wear-resistant ring 8 and annular hollow 9 are located overlapping each other in the piston axial direction.

Wear-resistant ring 8 as discussed above has been obtained by extensive experiments discussed below, conducted by the present inventors taking account of realizing a weight-lightening of a piston in view of the above-discussed technical problem and easiness and cost-reduction in forming operation for the piston.

### EXAMPLES

The present invention will be more readily understood with reference to the following Examples; however, these Examples are intended to illustrate the invention and are not to be construed to limit the scope of the invention.

Hereinafter, materials for wear-resistant ring 8 and basic forming methods for piston 1 will be discussed on experiments.

<First Step>

At first, a base material or matrix of wear-resistant ring 8 was prepared as follows: Chips of Ni-resist cast iron as metal oxide (ferrous material) is pulverized to obtain powder of Ni-resist cast iron. Then, the power was compressed to form a temporary formed body 10 which was a porous compact. This temporary formed body 10 basically represented a “compact”; however, for convenience, the term “temporary formed body” would be used from a step of impregnating pores of the temporary formed body with molten metals of Al and Mg to a Seventh Step discussed after.

The above-mentioned powder of Ni-resist cast ion was experimentally obtained by pulverizing the chips of Ni-resist case iron by a general laboratory small-size vibration mill, in which pulverization was made with rods for about 8 hours and with balls for about 4 hours (totally for 12 hours). The thus obtained powder was classified into segments which respectively have mean particle diameters of 50 μm, 100 μm, 200 μm, 400 μm, 600 μm, 800 μm and 100 μm.

<Second Step>

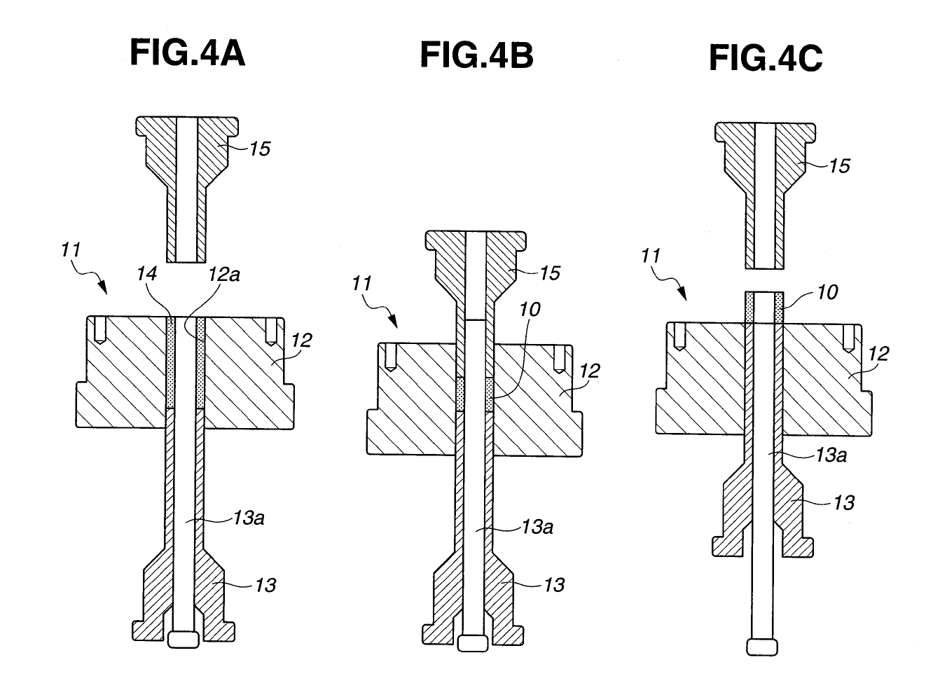

Next, the above powder of Ni-resist cast iron was pressurized by a usual punch forming machine 11 thereby forming temporary formed body 10. More specifically, as shown in FIG. 4A, first a lower punch 13 provided was inserted into a cylindrical cavity 12a of a forming die 12 from the lower side and positioned, in which a forming pin 13a had been inserted in the lower punch. In a state where lower punch 13 was positioned and maintained at a position of FIG. 4A, the above-mentioned powder of Ni-resist cast ion was filled in cavity 12a.

Subsequently, as shown in FIG. 4B, an upper punch 15 was inserted into cavity 12a from the upper side so as to pressurize the above-mentioned powder of Ni-resist cast ion at a certain pressure between it and lower punch 13 thereby forming temporary formed body 10 as the cylindrical compact.

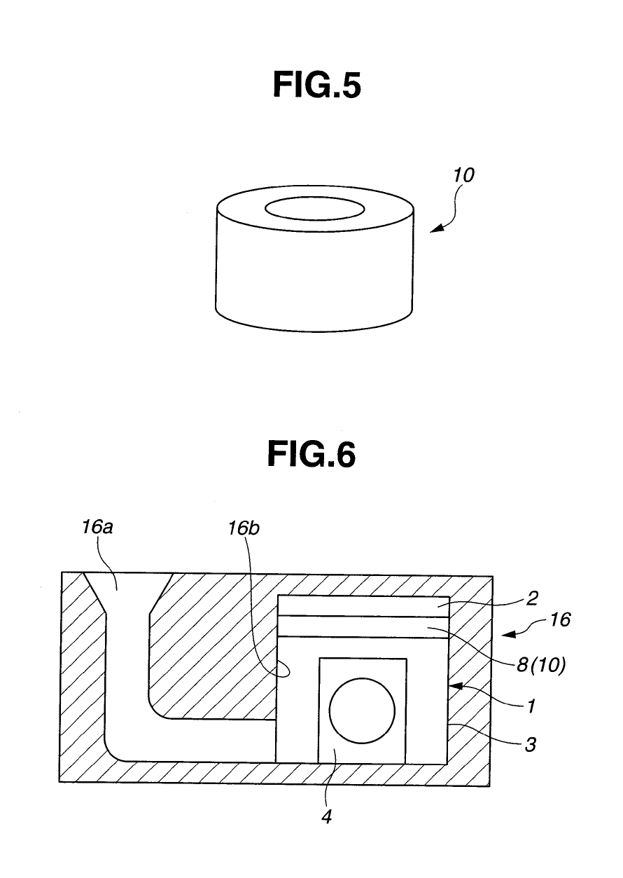

Thereafter, as shown in FIG. 4C, lower punch 13 and upper punch 15 were synchronously moved upward so as to take out temporary formed body 10 from forming die 12, thereby obtaining cylindrical temporary formed body 10 having an outer diameter of 16 mm, an inner diameter of 8 mm and a height of 10 mm as shown in FIG. 5.

In the experiments, when the forming was made by punch forming machine 11, the strokes of lower punch 13 and upper punch 15 were changed thereby obtaining temporary formed bodies (10) which respectively had densities or (g/cm³) of 3, 4, 5, 6, 7 and 7.8.

Each temporary formed body 10 was iron (Fe)-based and contained carbon (C), silicon (Si), Manganese (Mn), phosphorus (P), sulfur (S), nickel (Ni), chromium (Cr), copper (Cu) and the like in amounts (weight %) in maximum and in minimum, as shown in Table 1.

TABLE 1

| | C | Si | Mn | P | S | Ni | Cr | Cu |
|---|---|---|---|---|---|---|---|---|
| Minimum (wt %) | 2.2 | 1.5 | 1.0 | | | 13.5 | 1.7 | 5.5 |
| Maximum (wt %) | 2.7 | 2.2 | 1.5 | 0.1 | 0.1 | 17.5 | 2.5 | 7.5 |

Additionally, each temporary formed body 10 had a thermal expansion coefficient of 19.3×10⁻⁶ and a density of 3.0 to 7.8.

<Third Step>

Next, temporary formed body 10 as discussed above was sintered and formed in an atmosphere of mixture of hydrogen gas and nitrogen gas (H₂:N₂=3:1) and under the following conditions to produce a porous formed body (or sintered compact);

First, heating was made at 600° C. for 1 minute; Secondly, burning was made at 600° C. for 10 minutes; Thirdly, heating was again made at at 1150° C. for 15 minutes; Fourthly, burning was made at 1150° C. for 1 hour; Fifthly, heating upon a temperature lowering was made at 800° C. for 15 minutes; Sixthly, burning was made at 800° C. for 10 minutes; Seventhly, heating upon a temperature lowering was made at 500° C. for 15 minutes; Eighthly, burning was made at 500° C. for 10 minutes; and Lastly or Ninthly, heating upon a temperature lowering was made at 150° C. for 5 minutes to complete this step.

Additionally, a mixture molten metal of an aluminum alloy (Al) and a magnesium alloy (Mg) was prepared as discussed below in order that temporary formed body 10 which had been completed in sintering and forming would be dipped in the mixture molten metal.

A crucible was charged with an ingot of the Al alloy and the Mg alloy, and then dissolving was made at 750° C. thereby forming the mixture molten metal. In the experiments, the mixture molten metals were prepared by changing a ratio in charging amount or content (weight %) between Al and Mg as shown in Table 2.

TABLE 2

| | Al content (wt %) | Mg content (wt %) |
|---|---|---|
| 1 | 100 | 0 |
| 2 | 90 | 10 |
| 3 | 80 | 20 |
| 4 | 60 | 40 |
| 5 | 40 | 60 |
| 6 | 10 | 90 |

Additionally, in the experiments, a plurality of temporary formed bodies 10 having the different mean particle diameters as discussed above were heated in the atmosphere for 30 minute in the following condition to oxidize the surface of the powder of temporary formed bodies 10: A first condition was to make oxidization under no heating (at ordinary temperature or room temperature); A second condition was to make oxidization under heating at 500° C.; and A third condition was to make oxidization under heating at 1000° C.

<Fourth Step>

Next, respective temporary formed body 10 different from each other in mean particle diameter, density and heating condition were dipped for 10 minutes in molten metals (having a temperature of 750° C.) different in relative contents of the above-mentioned the Al alloy and the Mg alloy thereby accomplishing impregnation treatments of the mixture molten metals.

<Fifth Step>

Thereafter, each temporary formed body 10 was dipped in the molten metal of an Al alloy (having a temperature of 780° C.) which had a composition similar to that of pure aluminum of 99.7%, so that the Al alloy was adhered on the surface of the temporary formed body. This suppressed oxidation of Mg in the atmosphere.

<Sixth and Seventh Steps>

Subsequently, each temporary formed body 10 was kept cooled at ordinary temperature for a certain time (Sixth Step). Thereafter, temporary formed body 10 was again dipped in a molten metal of an Al alloy having an Al content of 99.7% so as to be preheated (Seventh Step). The molten metal temperature of this Al alloy was set at 780° C.

<Eighth Step>

Next, a formed body (wear-resistant ring 8) taken out from the above-mentioned molten metal of the Al alloy was set at a certain position within a cavity 16b formed in a casting die 16 for the piston as shown in FIG. 6. Thereafter, the molten metal of an Al alloy as the base material of the piston was poured into cavity 16b through a pouring opening 16a thereby accomplishing a so-called enveloped casting for wear-resistant ring 8 so that the wear-resistant ring was inserted in the base material of the piston. In this casting, the temperature of the molten metal was set at 750° C.; and a material AZ91C (in American Society of Testing and Materials) containing Mg, Zn and Mn in addition to Al was used as the material of the molten metal of the Al alloy. The AZ91C has a chemical composition (mass %) of Al: 8.1 to 9.3%, Zn: 0.40 to 1.0%, Mn: 0.13 to 0.35%, Si: 0.30% max., Cu: 0.10% max., and Mg: balance. Thus, the forming operation of piston 1 in which wear-resistant ring 8 was inserted was completed.

Formation of piston 1 having wear-resistant ring 8 was completed by a series of above-discussed steps, in which the present inventors conducted the following experiments at a stage where the fourth step was finished.

A plurality of formed bodies 10 taken out from the mixture molten metal of the Al alloy and the Mg alloy after dipping of the temporary formed bodies in the mixture molten metals were laterally (diametrically) cut to inspect an impregnation or infiltration property inside of each formed body 10. Results of these experiments are shown in Tables 3 to 5, in which Table 3 corresponds to a first condition where the heating temperature of temporary formed body 10 was ordinary temperature; Table 4 corresponds to a second condition where the heating temperature of temporary formed body 10 was 500° C.; and Table 5 corresponds to a third condition where the heating temperature of temporary formed body was 1000° C. In these Tables, “A” indicates an impregnation condition that the mixture molten metal was sufficiently infiltrated into the inside of temporary formed body 10 (also indicated as “Impregnated” in each Table); and “B” indicates another impregnation condition that temporary formed body 10 had a section in which no infiltration of the mixture molten metal was made (also indicated as “Non-impregnated” in each Table).

TABLE 3

| Mean particle | Density of | | | | | | |
|---|---|---|---|---|---|---|---|
| diameter of | formed body | Impregnation condition (A: Impregnated, B: Non-impregnated) | | | | | |
| powder (μm) | (g/cm³) | Al—0%Mg | Al—10%Mg | Al—20%Mg | Al—40%Mg | Al—60%Mg | Al—90%Mg |
| 50 | 3 | B | B | B | B | B | B |
| 50 | 4 | B | B | B | B | B | B |
| 50 | 5 | B | B | B | B | B | B |
| 50 | 6 | B | B | B | B | B | B |
| 50 | 7 | B | B | B | B | B | B |
| 50 | 7.8 | B | B | B | B | B | B |
| 100 | 3 | B | B | B | B | A | A |
| 100 | 4 | B | B | B | B | A | A |
| 100 | 5 | B | B | B | B | A | A |
| 100 | 6 | B | B | B | B | A | A |
| 100 | 7 | B | B | B | B | B | B |
| 100 | 7.8 | B | B | B | B | B | B |
| 200 | 3 | B | B | B | B | A | A |
| 200 | 4 | B | B | B | B | A | A |
| 200 | 5 | B | B | B | B | A | A |
| 200 | 6 | B | B | B | B | A | A |
| 200 | 7 | B | B | B | B | B | B |
| 200 | 7.8 | B | B | B | B | B | B |
| 400 | 3 | B | B | B | B | A | A |
| 400 | 4 | B | B | B | B | A | A |
| 400 | 5 | B | B | B | B | A | A |
| 400 | 6 | B | B | B | B | A | A |
| 400 | 7 | B | B | B | B | B | B |
| 400 | 7.8 | B | B | B | B | B | B |
| 600 | 3 | B | B | B | B | A | A |
| 600 | 4 | B | B | B | B | A | A |
| 600 | 5 | B | B | B | B | A | A |
| 600 | 6 | B | B | B | B | A | A |
| 600 | 7 | B | B | B | B | B | B |
| 600 | 7.8 | B | B | B | B | B | B |
| 800 | 3 | B | B | B | B | A | A |
| 800 | 4 | B | B | B | B | A | A |
| 800 | 5 | B | B | B | B | A | A |
| 800 | 6 | B | B | B | B | A | A |
| 800 | 7 | B | B | B | B | B | B |
| 800 | 7.8 | B | B | B | B | B | B |
| 1000 | 3 | B | B | B | B | A | A |
| 1000 | 4 | B | B | B | B | A | A |
| 1000 | 5 | B | B | B | B | A | A |
| 1000 | 6 | B | B | B | B | A | A |
| 1000 | 7 | B | B | B | B | B | B |
| 1000 | 7.8 | B | B | B | B | B | B |

TABLE 4

| Mean particle | Density of | | | | | | |
|---|---|---|---|---|---|---|---|
| diameter of | formed body | Impregnation condition (A: Impregnated, B: Non-impregnated) | | | | | |
| powder (μm) | (g/cm³) | Al—0%Mg | Al—10%Mg | Al—20%Mg | Al—40%Mg | Al—60%Mg | Al—90%Mg |
| 50 | 3 | B | B | B | B | B | B |
| 50 | 4 | B | B | B | B | B | B |
| 50 | 5 | B | B | B | B | B | B |
| 50 | 6 | B | B | B | B | B | B |
| 50 | 7 | B | B | B | B | B | B |
| 50 | 7.8 | B | B | B | B | B | B |
| 100 | 3 | B | B | B | A | A | A |
| 100 | 4 | B | B | B | A | A | A |
| 100 | 5 | B | B | B | A | A | A |
| 100 | 6 | B | B | B | A | A | A |
| 100 | 7 | B | B | B | B | B | B |
| 100 | 7.8 | B | B | B | B | B | B |
| 200 | 3 | B | B | B | A | A | A |
| 200 | 4 | B | B | B | A | A | A |
| 200 | 5 | B | B | B | A | A | A |
| 200 | 6 | B | B | B | A | A | A |
| 200 | 7 | B | B | B | B | B | B |
| 200 | 7.8 | B | B | B | B | B | B |
| 400 | 3 | B | B | B | A | A | A |
| 400 | 4 | B | B | B | A | A | A |
| 400 | 5 | B | B | B | A | A | A |
| 400 | 6 | B | B | B | A | A | A |
| 400 | 7 | B | B | B | B | B | B |
| 400 | 7.8 | B | B | B | B | B | B |
| 600 | 3 | B | B | B | A | A | A |
| 600 | 4 | B | B | B | A | A | A |
| 600 | 5 | B | B | B | A | A | A |
| 600 | 6 | B | B | B | A | A | A |
| 600 | 7 | B | B | B | B | B | B |
| 600 | 7.8 | B | B | B | B | B | B |
| 800 | 3 | B | B | B | A | A | A |
| 800 | 4 | B | B | B | A | A | A |
| 800 | 5 | B | B | B | A | A | A |
| 800 | 6 | B | B | B | A | A | A |
| 800 | 7 | B | B | B | B | B | B |
| 800 | 7.8 | B | B | B | B | B | B |
| 1000 | 3 | B | B | B | A | A | A |
| 1000 | 4 | B | B | B | A | A | A |
| 1000 | 5 | B | B | B | A | A | A |
| 1000 | 6 | B | B | B | A | A | A |
| 1000 | 7 | B | B | B | B | B | B |
| 1000 | 7.8 | B | B | B | B | B | B |

TABLE 5

| Mean particle | Density of | | | | | | |
|---|---|---|---|---|---|---|---|
| diameter of | formed body | Impregnation condition (A: Impregnated, B: Non-impregnated) | | | | | |
| powder (μm) | (g/cm³) | Al—0%Mg | Al—10%Mg | Al—20%Mg | Al—40%Mg | Al—60%Mg | Al—90%Mg |
| 50 | 3 | B | B | B | B | B | B |
| 50 | 4 | B | B | B | B | B | B |
| 50 | 5 | B | B | B | B | B | B |
| 50 | 6 | B | B | B | B | B | B |
| 50 | 7 | B | B | B | B | B | B |
| 50 | 7.8 | B | B | B | B | B | B |
| 100 | 3 | B | B | A | A | A | A |
| 100 | 4 | B | B | A | A | A | A |
| 100 | 5 | B | B | A | A | A | A |
| 100 | 6 | B | B | A | A | A | A |
| 100 | 7 | B | B | B | B | B | B |
| 100 | 7.8 | B | B | B | B | B | B |
| 200 | 3 | B | B | A | A | A | A |
| 200 | 4 | B | B | A | A | A | A |
| 200 | 5 | B | B | A | A | A | A |
| 200 | 6 | B | B | A | A | A | A |
| 200 | 7 | B | B | B | B | B | B |
| 200 | 7.8 | B | B | B | B | B | B |
| 400 | 3 | B | B | A | A | A | A |
| 400 | 4 | B | B | A | A | A | A |
| 400 | 5 | B | B | A | A | A | A |
| 400 | 6 | B | B | A | A | A | A |
| 400 | 7 | B | B | B | B | B | B |
| 400 | 7.8 | B | B | B | B | B | B |
| 600 | 3 | B | B | A | A | A | A |
| 600 | 4 | B | B | A | A | A | A |
| 600 | 5 | B | B | A | A | A | A |
| 600 | 6 | B | B | A | A | A | A |
| 600 | 7 | B | B | B | B | B | B |
| 600 | 7.8 | B | B | B | B | B | B |
| 800 | 3 | B | B | A | A | A | A |
| 800 | 4 | B | B | A | A | A | A |
| 800 | 5 | B | B | A | A | A | A |
| 800 | 6 | B | B | A | A | A | A |
| 800 | 7 | B | B | B | B | B | B |
| 800 | 7.8 | B | B | B | B | B | B |
| 1000 | 3 | B | B | A | A | A | A |
| 1000 | 4 | B | B | A | A | A | A |
| 1000 | 5 | B | B | A | A | A | A |
| 1000 | 6 | B | B | A | A | A | A |
| 1000 | 7 | B | B | B | B | B | B |
| 1000 | 7.8 | B | B | B | B | B | B |

As apparent from Table 3, it has been confirmed that a sufficient infiltration of the mixture molten metal was made in case that the mean particle diameter of the above-mentioned powder (14) is not smaller than 100 μm; the density of temporary formed body 10 is 3.0 to 6.0 g/cm³; and the content of Mg alloy in the mixture molten metal was 60 to 90 weight %. Additionally, from Table 4, it has been confirmed that a sufficient infiltration of the mixture molten metal is made in case that the mean particle diameter of the above-mentioned powder (14) is not smaller than 100 μm; the density of temporary formed body 10 is 3.0 to 6.0 g/cm³; and the content of Mg alloy in the mixture molten metal is 40 to 90 weight %. Further, from Table 5, it has been confirmed that a sufficient infiltration of the mixture molten metal is made in case that the mean particle diameter of the above-mentioned powder (14) is not smaller than 100 μm; the density of temporary formed body 10 is 3.0 to 6.0 g/cm³; and the content of Mg alloy in the mixture molten metal is 20 to 90 weight %.

Accordingly, a sufficient infiltration property of the mixture molten metal to temporary formed body 10 can be obtained at least a region filled with “A” in Tables 3 to 5. Hence, desired wear-resistant ring 8 can be produced by selecting any of regions filled with “A” in Tables 3 to 5.

Additionally, from the experimental results of Tables 3 to 5, the relationship between the content (weight %) of Mg of the mixture molten metal and the temperature for the oxidation is as shown in Table 6 in case that the mean particle diameter of powder 14 of the Ni-resist cast iron is 600 μm and the density of temporary formed body 10 was 6.0 g/cm³.

TABLE 6

Impregnation condition
according to oxidation temp.
(A: Impregnated, B: Non-impregnated)

| | Ordinary | | |
|---|---|---|---|
| Mg content (wt %) | temp. | 500° C. | 1000° C. |
| 0 | B | B | B |
| 10 | B | B | B |
| 20 | B | B | A |
| 40 | B | A | A |
| 60 | A | A | A |
| 80 | A | A | A |
| 90 | A | A | A |

As will be apparent from Table 6, it has been confirmed that a sufficient infiltration of the mixture molten metal can be obtained with 60 weight % of the Mg alloy even if any heating temperature (ordinary temperature to 1000° C.) for temporary formed body 10 is employed. In case that the heating temperature for temporary formed body 10 was 1000° C., it is apparent that a sufficient infiltration of the mixture molten metal can be obtained. It will be understood that an optimum infiltration or impregnation property can be secured by setting the conditions of impregnation of temporary formed body 10 with the mixture molten metal within regions filled with “A” in FIG. 6.

Next, the relationship between the mean particle diameter (μm) of powder 14 and the density (g/cm³) of temporary formed body 10 is shown in Table 7, in case that temporary formed body 10 sintered at a heating temperature of 1000° C. for a heating time of 10 minutes is dipped in the mixture molten metal having the Mg alloy amount of 90 weight %.

TABLE 7

| Powder | Impregnation condition according to density of formed body | | | | | |
|---|---|---|---|---|---|---|
| particle | (A: Impregnated, B: Non-impregnated) | | | | | |
| diameter | 3 | 4 | 5 | 6 | 7 | 8 |
| (μm) | (g/cm³) | (g/cm³) | (g/cm³) | (g/cm³) | (g/cm³) | (g/cm³) |
| 50 | B | B | B | B | B | B |
| 100 | A | A | A | A | B | B |
| 200 | A | A | A | A | B | B |
| 400 | A | A | A | A | B | B |
| 600 | A | A | A | A | B | B |
| 800 | A | A | A | A | B | B |
| 1000 | A | A | A | A | B | B |

Table 7 depicts that the above-mentioned mixture molten metal can be sufficiently infiltrated in pores of porous temporary formed body 10 if the mean particle diameter of powder 14 is not smaller than 100 μm and the density of the temporary formed body is not higher than 6.0 g/cm³.

As will be understood from the experimental results shown in Tables, the mixture molten metal of the Al alloy and the Mg alloy can be sufficiently infiltrated into temporary formed body 10 if wear-resistant ring (or formed body) 8 is produced under conditions where the mean particle diameter of powder 14 of Ni-resist cast iron is 100 to 1000 μm; the density of temporary formed body 10 is 3.0 to 6.0 g/cm³; the heating temperature and time for temporary formed body 10 are respectively about 1000° C. and about 30 minutes; and the amount of the Mg alloy in the mixture molten metal is 60 to 90 weight %. The best wear-resistant ring 8 will be obtained preferably under conditions where the mean particle diameter of powder 14 of Ni-resist cast iron is about 600 μm; the density of temporary formed body 10 is about 5.0 g/cm³; the heating temperature and time for temporary formed body 10 are respectively about 1000° C. and about 30 minutes; and the amount of the Mg alloy in the mixture molten metal is about 90 weight %.

<Mechanism of Self-Infiltration of Mixture Molten Metal in Examples>

Hereinafter, consideration will be made on the self-infiltration of the mixture molten metal of the Al alloy and the Mg alloy to the temporary formed body 10 in the above-mentioned fourth step.

Immediately after the dipping of temporary formed body 10 (sintered compact) in the mixture molten metal in the fourth step, confined air in the temporary formed body maintained a pressure depending upon the number of moles and the combined gas law. Against this pressure, a pressure obtained by adding the atmospheric pressure and the gravity of the mixture molten metal of the Al alloy and the Mg alloy is applied as an external force to sintered temporary formed body 10. Preheating temporary formed body 10 immediately before the dipping to raise the temperature of the temporary formed body to a temperature near to that of the molten metal is considered to be effective to suppress the internal pressure (the number of moles of air) of temporary formed body 10 after the dipping, at a lower level.

Temporary formed body 10 cannot be wetted with the mixture molten metal covered with the film of magnesium oxide (MgO) at micro-level, and therefore an osmotic pressure exists in a direction to prevent infiltration of the mixture molten metal under the action of the interfacial force.

When the temperature of the above-mentioned mixture molten metal became about 1023 K (750° C.), magnesium in a composition evaporates into the atmosphere thereby producing magnesium nitride (Mg₃N₂) thus consuming nitrogen in the pores of temporary formed body 10.

N₂(G)+3Mg(G)→Mg₃N₂(S)

The surfaces of the particles of the powder of temporary formed body 10 are coated with produced magnesium nitride (Mg₃N₂) thereby reducing the oxide film of the mixture molten metal thus improving the wetting property of the mixture molten metal, by which the osmotic pressure is raised.

When the mixture molten metal is brought into contact with the iron oxide of temporary formed body 10 upon breaking of film of the above-mentioned MgO, for example, under vibration of the mixture molten metal, thermite reaction is initiated.

4Mg+Fe₃O₅=4Mg+3Fe−77 kcal/mol

Mg+FeO═MgO+Fe−80.5 kcal/mol

By this exothermic reaction, production of Mg₃N₂ (S) and reduction of oxide film (MgO) proceed, and oxidation by O₂ within temporary formed body 10 proceeds at the surface of the mixture molten metal contacting with air.

Nitrogen and oxygen are consumed to lower a partial pressure which approaches a vapor pressure of Mg, so that the mixture molten metal can be sufficiently infiltrated into pores of temporary formed body 10 under the resultant force of the atmospheric pressure and the gravity of the mixture molten metal.

With such infiltration mechanism, the mixture molten metal can sufficiently infiltrate into temporary formed body 10. Accordingly, finally resultant wear-resistant ring 8 can be sharply light-weighted under the porosity of Ni-resist cast iron and the infiltration of the Al alloy and the Mg alloy, over a conventional wear-resistant ring formed of single Ni-resist cast iron. As a result, a sharp weight-lightening can be achieved also on the whole body of piston 1 in which wear-resistant ring 8 is inserted. By this, vibration noise of an engine can be suppressed while making it possible to reduce friction of wear-resistant ring 8 against the wall of a cylinder bore. Besides, the infiltration time of the mixture molten metal into temporary formed body 10 can be shortened under the above-discussed infiltration mechanism, thereby improving an operational efficiency of production of the piston while lowering a production cost of the piston.

Further, in the Examples, the mixture molten metal of the Al alloy and the Mg alloy is infiltrated into temporary formed body 10 not only by the pressure of the mixture molten metal but also by using a heat generation due to oxidation and reduction reactions. Accordingly, no large-sized pressurizing apparatus is necessary so as to achieve a sharp reduction of production cost from this view point. Furthermore, temporary formed body 10 is formed by using powder of Ni-resist iron, thereby achieving a reduction of cost of materials.

It will be understood that the present invention is not limited to the forming method of the above-discussed Examples, so that powder of Ni-resist cast iron may not be used as the material of temporary formed body 10, using powder of other ferrous metals in place thereof. Additionally, the sintering operation of temporary formed body 10 at the third step may be omitted, so that the compact as it is be subjected to the operation of the fourth step thereby improving the operational efficiency under omission of the third step.

Further, it is possible to omit the above-discussed sixth step (temporary formed body 10 being kept cooled) and seventh step (temporary formed body 10 being again dipped in a molten metal). In other words, the sixth and seventh steps serve to allow a cycle timing to meet the next eighth step, and therefore the sixth and seventh steps can be omitted if the cycle timing can be met. This further improves the operational efficiency. Furthermore, the dipping operation of temporary formed body 10 in the Al alloy molten metal may be omitted like the sixth and seventh steps if the transition of the operation of the fourth step to the operation of the eighth step is smoothly made to suppress oxidation of Mg. Moreover, it will be understood that the sliding member is not limited to the above-mentioned wear-resistant ring 8, and therefore it may be other ones which are used in various devices and various engines.

Next, discussion will be made on technical ideas (a) to (o) grasped from the above embodiments.

(a) A piston of an internal combustion engine, comprising: a crown section; and a wear-resistant ring formed in the crown section to be used for forming a piston ring groove, the wear-resistant ring including a porous formed body formed of a first material higher in hardness and larger in specific gravity than a base material of the piston, and a second material infiltrated in pores of the porous formed body and containing 20 weight % or more of magnesium.

(b) A piston of an internal combustion engine, comprising: a crown section; and a wear-resistant ring formed in the crown section to be used for forming a piston ring groove, the wear-resistant ring being produced by a process including preparing a porous temporary formed body formed of a first material higher in hardness and larger in specific gravity than a base material of the piston, and infiltrating a second material in pores of the porous temporary formed body, the second material containing 20 weight % or more of magnesium.

(c) A method of producing a piston of an internal combustion engine, including a crown section, and a wear-resistant ring formed in the crown section to be used for forming a piston ring groove, the method comprising in the sequence set forth: preparing a temporary formed body formed by solidifying powder of metal oxide which is higher in hardness and larger in specific gravity than a base material of the piston, the temporary formed body having pores; infiltrating a metal material smaller in specific gravity than the base material of the piston, into the pores of the temporary formed body under oxidation and reduction reactions between the temporary formed body and the metal material so as to form the heat-resistant ring; and fixing the heat-resistant ring in the crown section of the piston during casting of the base material of the piston.

(d) A sliding member comprising: a base section; and a wear-resistant section higher in wear-resistance than a base material of the sliding member, partially formed in the sliding member, the wear-resistant section including a porous formed body formed of a first material higher in hardness and larger in specific gravity than the base material of the sliding member, and a second material infiltrated in pores of the porous formed body and containing 20 weight % or more of magnesium.

(e) A sliding member comprising: a base section; and a wear-resistant section higher in wear-resistance than a base material of the sliding member, partially formed in the base section, the wear-resistant section being produced by a process including preparing a porous temporary formed body formed of a first material higher in hardness and larger in specific gravity than the base material of the sliding member, and infiltrating a second material in pores of the porous temporary formed body, the second material containing 20 weight % or more of magnesium.

(f) A piston of an internal combustion engine, as recited at (b), wherein the porous temporary formed body is formed by solidifying metal powder.

(g) A piston of an internal combustion engine, as recited at (f), wherein the porous temporary formed body is a compact of the metal powder.

(h) A piston of an internal combustion engine, as recited at (f), wherein the metal powder of the porous temporary formed body has a mean particle diameter of not smaller than 100 μm and a density of not smaller than 3.0 g/cm³.

(i) A piston of an internal combustion engine, as recited at (f), wherein the metal powder is formed of iron-based metal.

(j) A piston of an internal combustion engine, as recited at (f), wherein the metal powder is formed of Ni-resist cast iron.

(k) A piston of an internal combustion engine, as recited at (b), wherein the base material of the piston is an aluminum alloy.

(l) A piston of an internal combustion engine, as recited at (b), wherein the base material of the piston is a magnesium alloy. According to this idea, a further weight-lightening of the whole piston can be achieved.

(m) A method of producing a piston of an internal combustion engine, as recited at (c), wherein the temporary formed body is a compact which is formed merely by pressurizing powder.

(n) A method of producing a piston of an internal combustion engine, as recited at (c), wherein the metal material smaller in specific gravity than the base material of the piston is infiltrated into the temporary formed body at atmospheric pressure.

(o) A method of producing a piston of an internal combustion engine, as recited at (c), wherein fixing the heat-resistant ring in the crown section of the piston during casting of the base material of the piston includes dipping the heat-resistant ring in a mixture molten metal of aluminum alloy and magnesium alloy, and thereafter casting the base material of the piston in a manner that the heat-resistant ring is inserted in the base material of the piston. According to this idea, after the wear-resistant ring is dipped in the mixture molten metal of the aluminum alloy and the magnesium alloy, casting of the base material is swiftly made in a state where the heat-resistant ring is inserted in the base material, within a time for which no oxidation occurs. This makes it possible to shorten an operational time for forming the piston.

The entire contents of Japanese Patent Applications P2010-291662, filed Dec. 28, 2010, are incorporated herein by reference.

Although the invention has been described above by reference to certain embodiments and examples of the invention, the invention is not limited to the embodiments and examples described above. Modifications and variations of the embodiments and examples described above will occur to those skilled in the art, in light of the above teachings. The scope of the invention is defined with reference to the following claims.

What is claimed is:

1. A piston of an internal combustion engine, comprising:
a crown section; and
a wear-resistant ring formed in the crown section to be used for forming a piston ring groove, the wear-resistant ring including a porous formed body formed of a first material higher in hardness and larger in specific gravity than a base material of the piston, and a second material infiltrated in pores of the porous formed body and containing 20 weight % or more of magnesium.

2. A piston of an internal combustion engine, comprising:
a crown section; and
a wear-resistant ring formed in the crown section to be used for forming a piston ring groove, the wear-resistant ring being produced by a process including preparing a porous temporary formed body formed of a first material higher in hardness and larger in specific gravity than a base material of the piston, and infiltrating a second material in pores of the porous temporary formed body, the second material containing 20 weight % or more of magnesium.

3. A method of producing a piston of an internal combustion engine, including a crown section, and a wear-resistant ring formed in the crown section to be used for forming a piston ring groove, the method comprising in the sequence set forth:
preparing a temporary formed body formed by solidifying powder of metal oxide which is higher in hardness and larger in specific gravity than a base material of the piston, the temporary formed body having pores;
infiltrating a metal material smaller in specific gravity than the base material of the piston, into the pores of the temporary formed body under oxidation and reduction reactions between the temporary formed body and the metal material so as to form the heat-resistant ring; and
fixing the heat-resistant ring in the crown section of the piston during casting of the base material of the piston.

4. A sliding member comprising:
a base section; and
a wear-resistant section higher in wear-resistance than a base material of the sliding member, partially formed in the sliding member, the wear-resistant section including a porous formed body formed of a first material higher in hardness and larger in specific gravity than the base material of the sliding member, and a second material infiltrated in pores of the porous formed body and containing 20 weight % or more of magnesium.

5. A sliding member comprising:
a base section; and
a wear-resistant section higher in wear-resistance than a base material of the sliding member, partially formed in the base section, the wear-resistant section being produced by a process including preparing a porous temporary formed body formed of a first material higher in hardness and larger in specific gravity than the base material of the sliding member, and infiltrating a second material in pores of the porous temporary formed body, the second material containing 20 weight % or more of magnesium.

6. A piston of an internal combustion engine, as claimed in claim 2, wherein the porous temporary formed body is formed by solidifying metal powder.

7. A piston of an internal combustion engine, as claimed in claim 6, wherein the porous temporary formed body is a compact of the metal powder.

8. A piston of an internal combustion engine, as claimed in claim 6, wherein the metal powder of the porous temporary formed body has a mean particle diameter of not smaller than 100 μm and a density of not smaller than 3.0 g/cm³.

9. A piston of an internal combustion engine, as claimed in claim 6, wherein the metal powder is formed of iron-based metal.

10. A piston of an internal combustion engine, as claimed in claim 6, wherein the metal powder is formed of Ni-resist cast iron.

11. A piston of an internal combustion engine, as claimed in claim 2, wherein the base material of the piston is an aluminum alloy.

12. A piston of an internal combustion engine, as claimed in claim 2, wherein the base material of the piston is a magnesium alloy.

13. A method of producing a piston of an internal combustion engine, as claimed in claim 3, wherein the temporary formed body is a compact which is formed merely by pressurizing powder.

14. A method of producing a piston of an internal combustion engine, as claimed in claim 3, wherein the metal material smaller in specific gravity than the base material of the piston is infiltrated into the temporary formed body at atmospheric pressure.

15. A method of producing a piston of an internal combustion engine, as claimed in claim 3, wherein fixing the heat-resistant ring in the crown section of the piston during casting of the base material of the piston includes dipping the heat-resistant ring in a mixture molten metal of aluminum alloy and magnesium alloy, and thereafter casting the base material of the piston in a manner that the heat-resistant ring is inserted in the base material of the piston.
